(19) United States
(12) Patent Application Publication
(10) Pub. No.: US 2026/0105365 A1
(43) Pub. Date: Apr. 16, 2026

(54) Scaling Forward Gradient with Local Optimization

(71) Applicant: Google LLC, Mountain View, CA (US)

(72) Inventors: Simon Kornblith, Toronto (CA); Geoffrey Everest Hinton, Toronto (CA); Mengye Ren, New York, NY (US); Renjie Liao, Vancouver (CA)

(21) Appl. No.: 19/115,699

(22) PCT Filed: Sep. 26, 2023
(86) PCT No.: PCT/US2023/075155

§ 371 Date: Mar. 26, 2025

Related U.S. Application Data
(60) Provisional application No. 63/410,584, filed on Sep. 27, 2022.

(51) Int. Cl. G06N 20/00

(52) U.S. Cl. CPC G06N 20/00

(57) ABSTRACT

A plurality of model portions are determined from a machine-learned model based on at least one criterion. A plurality of local optimization functions are respectively determined for the plurality of model portions. Forward-mode differentiation is performed for each model portion of the plurality of model portions. Performing forward-mode differentiation includes applying a perturbation to outputs of one or more model units of the model portion. Performing forward-mode differentiation includes, based at least in part on the perturbation, determining a gradient of the local optimization function for the model portion. Performing forward-mode differentiation includes modifying one or more parameters of the model portion based on the gradient.

### PRIORITY CLAIM

The present application is based on and claims priority to U.S. Provisional Application 63/410,584 having a filing date of Sep. 27, 2022, which is incorporated in its entirety by reference herein.

### FIELD

The present disclosure relates generally to training machine-learned models. More particularly, the present disclosure relates to forward gradient learning via activity perturbation.

### BACKGROUND

Machine-learned models are partially inspired by the structure and function of the human brain. In particular, some types of machine-learned models, such as neural networks, include non-linear model units that emulate the biological function of neurons within the brain (e.g., activation functions, etc.). Conventionally, many of these models are trained by adjust values associated with these model units using backpropagation. However, backpropagation is considered by many to be biologically implausible, as it would require the brain to form symmetric backwards connections.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes determining, by a computing system comprising one or more computing devices, a plurality of model portions from a machine-learned model based on at least one criterion. The method includes respectively determining, by the computing system, a plurality of local optimization functions for the plurality of model portions. The method includes performing, by the computing system, forward-mode differentiation for each model portion of the plurality of model portions. Performing the forward-mode differentiation includes applying, by the computing system, a perturbation to outputs of one or more model units of the model portion. Performing the forward-mode differentiation includes, based at least in part on the perturbation, determining, by the computing system, a gradient of the local optimization function for the model portion. Performing the forward-mode differentiation includes modifying, by the computing system, one or more parameters of the model portion based on the gradient.

Another example aspect of the present disclosure is directed to a computing system, comprising one or more processors and one or more non-transitory, computer-readable media that store instructions that when executed by the one or more processors cause the computing system to perform operations. The operations include determining a plurality of model portions from a machine-learned model based on at least one criterion. The operations include respectively determining a plurality of local optimization functions for the plurality of model portions. The operations include performing forward-mode differentiation for each model portion of the plurality of model portions. Performing the forward-mode differentiation includes applying a perturbation to outputs of one or more model units of the model portion. Performing the forward-mode differentiation includes, based at least in part on the perturbation, determining a gradient of the local optimization function for the model portion. Performing the forward-mode differentiation includes modifying one or more parameters of the model portion based on the gradient.

Another example aspect of the present disclosure is directed to one or more non-transitory, computer-readable media that store instructions that when executed by one or more processors cause the one or more processors to perform operations. The operations include determining a plurality of model portions from a machine-learned model based on at least one criterion. The operations include respectively determining a plurality of local optimization functions for the plurality of model portions. The operations include performing forward-mode differentiation for each model portion of the plurality of model portions. Performing the forward-mode differentiation includes applying a perturbation to outputs of one or more model units of the model portion. Performing the forward-mode differentiation includes, based at least in part on the perturbation, determining a gradient of the local optimization function for the model portion. Performing the forward-mode differentiation includes modifying one or more parameters of the model portion based on the gradient.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs forward gradient learning according to example embodiments of the present disclosure.

FIG. 1B depicts a block diagram of an example computing device that performs forward-mode automatic differentiation according to example embodiments of the present disclosure.

FIG. 1C depicts a block diagram of an example computing device that performs training of a machine-learned model via forward-mode automatic differentiation according to example embodiments of the present disclosure.

FIG. 2 is a data flow diagram for an example architecture of a machine-learned model that includes a plurality of portions and a plurality of corresponding local optimization functions according to some implementations of the present disclosure.

FIG. 3 is a detailed data flow diagram for a local mixer residual block that is, or otherwise includes, one or more portions of a machine-learned model according to some implementations of the present disclosure.

FIG. 4 illustrates an example feature aggregator architecture according to some implementations of the present disclosure.

FIG. 5 depicts a flow chart diagram of an example method to perform forward gradient learning according to example embodiments of the present disclosure.

Reference numerals that are repeated across plural figures are intended to identify the same features in various implementations.

### DETAILED DESCRIPTION

### Overview

Generally, the present disclosure is directed to training machine-learned models via forward gradient learning. More particularly, the present disclosure relates to performance of forward-mode differentiation in conjunction with activity perturbation for training of machine-learned models without the need for backpropagation. In particular, forward-mode differentiation has been proposed as a biologically plausible alternative to backpropagation for training of machine-learned models. However, standard forward gradient algorithms suffer from the curse of dimensionality (i.e., do not scale efficiently with the size of the machine-learned model). Accordingly, implementations of the present disclosure propose scaling forward gradients with localized optimization functions.

For example, a computing system (e.g., a system that provides model training services) can determine a plurality of model portions from a machine-learned model based on at least one criterion (e.g., a blockwise loss criterion, a patchwise loss criterion, a channel-wise loss criterion, etc.). The computing system can respectively determine a plurality of local optimization functions for the plurality of model portions (e.g., localized greedy loss functions, etc.). The computing system can perform forward-mode differentiation for each model portion of the plurality of model portions.

To perform forward-mode differentiation, the computing system can apply a perturbation to outputs of one or more model units of the model portion (e.g., adding noise to the inputs to an activation function, etc.). Based at least in part on the perturbation, the computing system can determine a gradient of the local optimization function for the model portion and modify one or more parameters of the model portion based on the gradient. In such fashion, the computing system can efficiently determine a local gradient for each portion of the machine-learned model in an efficient and accurate manner.

Aspects of the present disclosure provide a number of technical effects and benefits. As one example technical effect and benefit, standard forward gradient algorithms suffer from the curse of dimensionality, which leads to prohibitively high computational requirements for training larger models. However, implementations of the present disclosure propose to scale forward gradient by adding multiple local optimization functions for discrete portions of the machine-learned model. By scaling the forward gradient with local optimization functions, implementations of the present disclosure can substantially reduce the computational resources required to perform forward gradient training of machine-learned models (e.g., power, compute cycles, memory, storage, etc.).

With reference now to the Figures, example embodiments of the present disclosure will be discussed in further detail.

### Example Devices and Systems

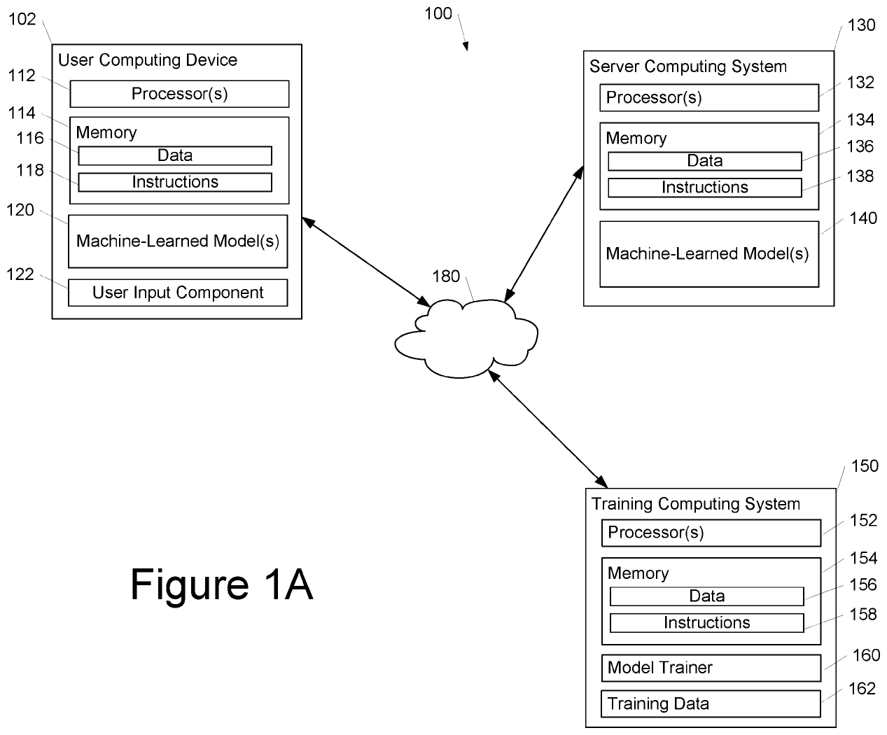

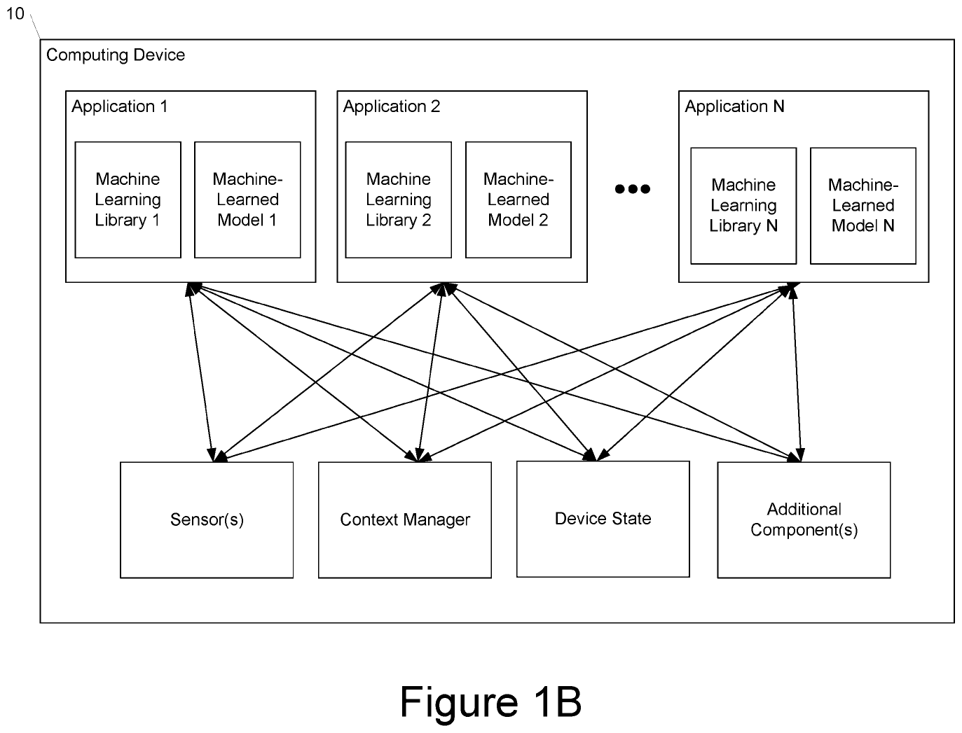

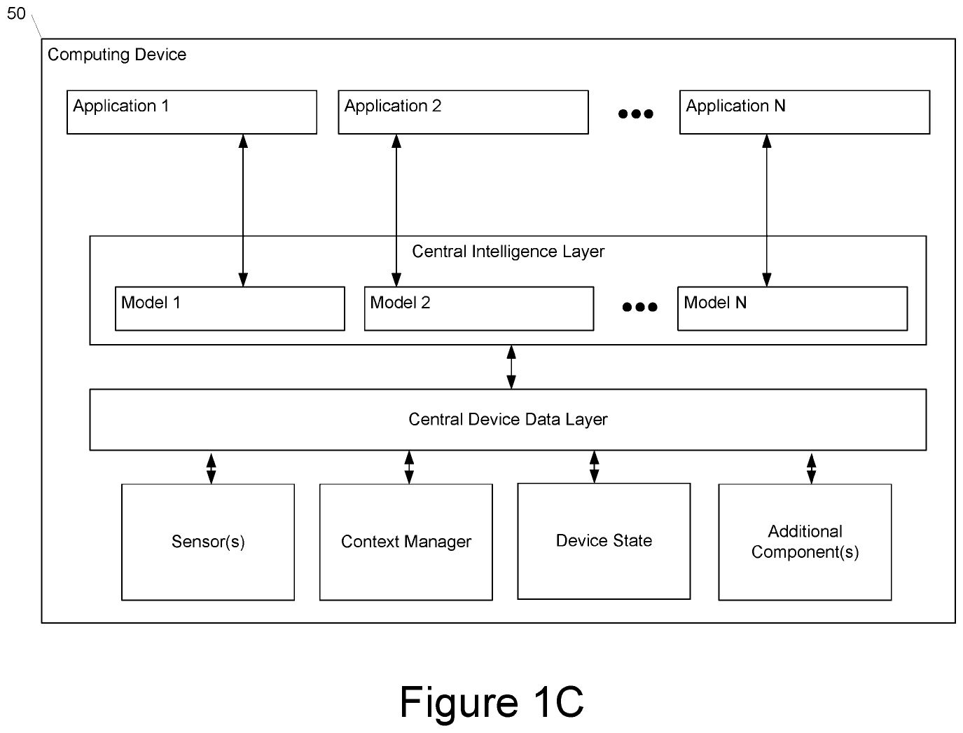

FIG. 1A depicts a block diagram of an example computing system 100 that performs forward gradient learning according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120 (e.g., to perform parallel services across multiple instances of the model).

Additionally or alternatively, one or more models 140 can be included in or otherwise stored and implemented by the server computing system 130 that communicates with the user computing device 102 according to a client-server relationship. For example, the models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM. EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, forward propagation of errors. For example, a loss function can be backpropagated or forward propagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In particular, the model trainer 160 can train the machine-learned models 120/140 via forward gradient learning. For example, the model trainer 160 can perform forward-mode automatic differentiation to train the models 120/140 according to a forward gradient. To find the forward gradient, the model trainer 160 can perform activity perturbation to determine forward gradients. For example, the model trainer 160 may divide the models 120/140 into a plurality of portions and determine an optimization function for each portion (e.g., according to certain criterions, etc.). The model trainer 160 can perturb the outputs of model units (e.g., neurons, etc.) included in each portion of the models to determine the forward gradient in accordance with the local optimization function associated with the portion.

In some implementations, performing backwards propagation of errors can include performing truncated backpropagation through time. The model trainer 160 can perform a number of generalization techniques (e.g., weight decays, dropouts, etc.) to improve the generalization capability of the models being trained. In particular, the model trainer 160 can train the models 120 and/or 140 based on a set of training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP. HTTP, SMTP. FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g, one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs forward-mode automatic differentiation according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs training of a machine-learned model via forward-mode automatic differentiation according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

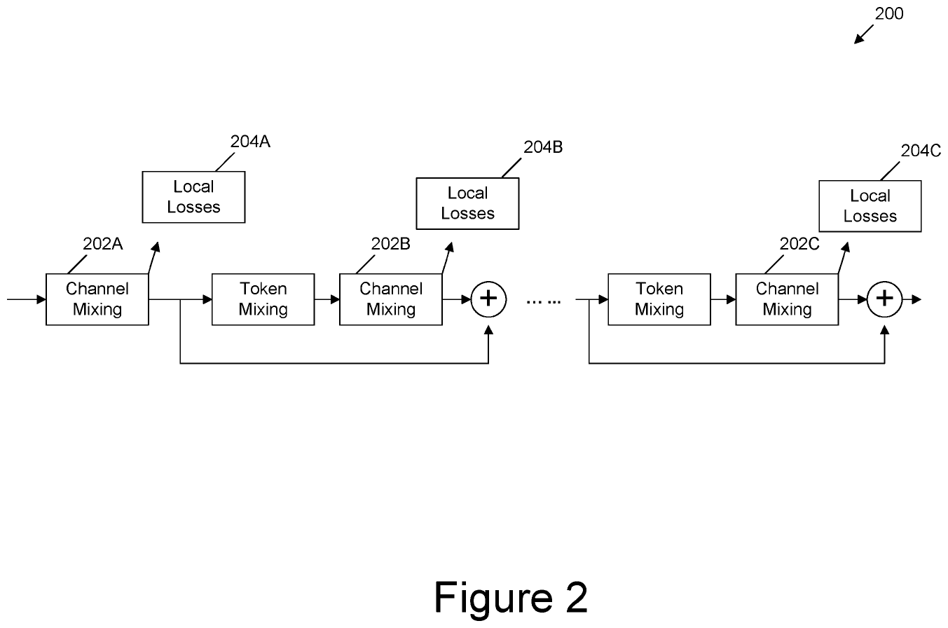

FIG. 2 is a data flow diagram for an example architecture of a machine-learned model 200 that includes a plurality of portions and a plurality of corresponding local optimization functions according to some implementations of the present disclosure. In particular, machine-learned model 200 includes a plurality of model portions 202A, 202B, and 202C. As depicted, each model portion 202A-202C is a mixer residual block. However, it should be noted that the model portions can be determined in any manner, and therefore can include any particular layer(s) of the machine-learned model. A plurality of local optimization functions 204A, 204B, and 204C can be respectively utilized to train the portions 202A-202C. For example, a linear projector layer may be utilized to attach each local optimization function 204A-204C to their respective model portions 202A-202C.

More specifically, the model portions 202A-202C can be mixer residual blocks that collectively form a local mixer network 200. The local mixer network 200 can be trained with local losses 204A-204C. The local losses 204A-204C can include any type or manner of loss or optimization function.

For example, the local loss 204A can be or otherwise include a blockwise loss. The blockwise loss can be a loss function that is computed at the “end” of each model portion 202A-202C. The blockwise loss can be utilized to update the parameters of that particular model portion. In this manner, the blockwise loss can serve as a “stop gradient” operator between modules.

For another example, the local loss 204B can be, or otherwise include, a patchwise loss that is applied along spatial dimensions of sensory input signals, such as images. Here, each spatial “token” can represent a patch in an image. Parameters from each spatial location can be shared to improve data efficiency and reduce memory bandwidth utilization. In some implementations, this weight sharing effect can be mimicked, or otherwise implemented, via knowledge distillation techniques.

For yet another example, the local loss 204C can be, or otherwise include, a groupwise loss that evaluates the channel dimension. To do so, channels can be split into a number of groups, and each group can be attached to a loss function (e.g., one of the local losses 204). To prevent groups of channels from communicating between each other, the channels are only connected to other channels within the same group. A grouped linear layer can be computed as z_{g,j}=Σᵢ w_{g,i,j}w_{g,i} for an individual model portion g.

In some implementations, feature aggregators can be utilized to aggregate information from other groups and spatial patches before the local loss function 204.

The local losses 204 can be applied to meet particular learning objectives. More specifically, the local losses 204 can collectively implement, or can be included in, supervised classification loss and contrastive loss. These losses, which are most commonly used in image representation learning, can be applied to optimize models in the manner described herein.

In some implementations, the local losses 204 implement a supervised classification loss. In some implementations, if the local losses 204 implement a supervised classification loss, the supervised classification loss can be implemented by attaching a shared linear layer (e.g., shared across p, g) on top of aggregated features for a cross entropy loss

$${L}_{{p}_{,} g}^{s} = - {\sum }_{k} {t}_{k} log {softmax ( {W}_{l} {\overline{x}}_{{p}_{,} g} )}_{k} .$$

This loss can be of the same value across each group and patch location.

Additionally, or alternatively, in some implementations, the local losses 204 implement a contrastive loss function. If the local losses 204 implement a contrastive loss function, the linear layer can become a linear feature projector. For example, suppose

$${x}_{n}^{( 1 )} and {x}_{n}^{( 2 )}$$

are the two airerent views of the n-th example, the loss for contrastive learning can be represented as:

$${L}_{p , g}^{c} = - {\sum }_{n} log \frac{{( W {\overline{x}}_{n , p , g}^{( 1 )} )}^{T} StopGrad ( W {\overline{x}}_{n}^{( 2 )} )}{{\sum }_{m} {( W {\overline{x}}_{n , p , g}^{( 1 )} )}^{T} StopGrad ( W {\overline{x}}_{n}^{( 2 )} )}$$

It should be noted that a stop gradient operator is added on the second view to force the loss to reduce. This is due to perturbation sharing between both views, and thus having the same perturbation will increase the dot product between the two views, which is not desired from a representation learning perspective.

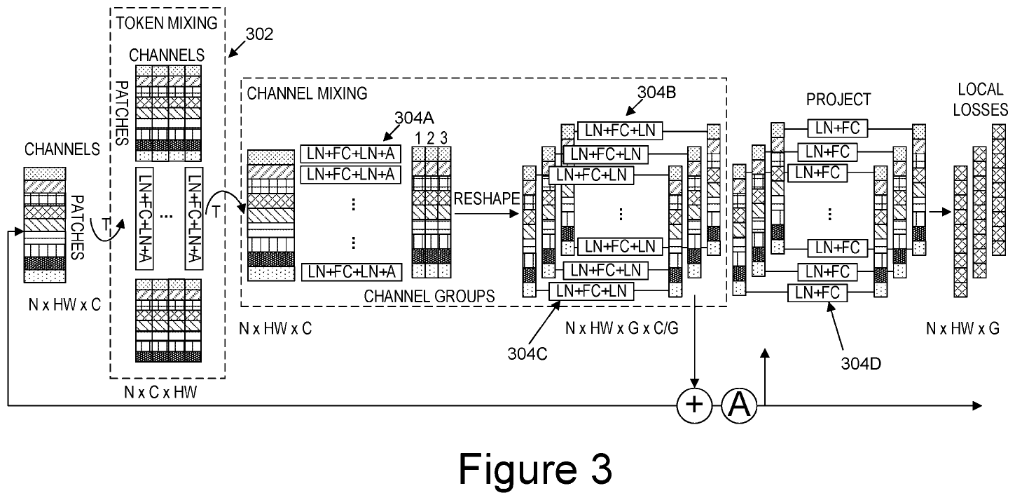

FIG. 3 is a detailed data flow diagram for a local mixer residual block that is, or otherwise includes, one or more portions of a machine-learned model according to some implementations of the present disclosure. In particular, as depicted, token mixing can be performed at 302, and can consist of a linear layer and channels that are grouped in the channel mixing layers. In particular, layers 304 can include LN (layer norm), FC (fully connected layer), A (activation function) and T (Transpose).

More specifically, at 302, token mixing can be performed. This manner of token mixing 302 can be the same as the token mixing described with regards to FIG. 2. To perform the token mixing, channels

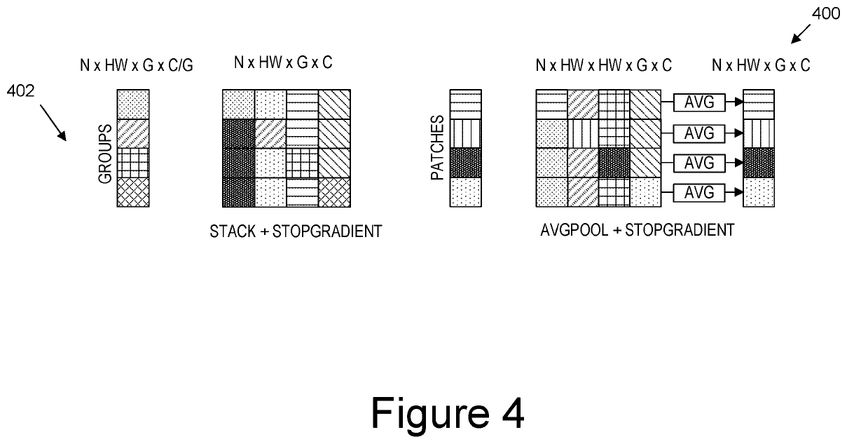

FIG. 4 illustrates an example feature aggregator architecture 400 according to some implementations of the present disclosure. In particular, rather than perform average pooling to aggregate features from different spatial locations as is performed in conventional designs, in implementations of the present disclosure features are first concatenated across groups and then averaged across spatial locations. Copies of the same feature can be created with different stop gradient masks so that more local losses are obtained instead of a global loss. The stop gradient mask ensures that perturbation in one spatial group corresponds to its loss function. The numerical value of the loss function calculated can be similar or identical to that of a more conventional design.

More specifically, to perform aggregation without reducing the total number of dimensions, channel groups 402 can first be copied and communicated to one another. Feature aggregation can be performed without reduction of total dimensionality. To do so, every group except for the active group (e.g., the group from which communication is occurring) can be masked with the stop gradient mask so that other groups do not affect the forward gradient computation, which can be represented as:

$${\overline{x}}_{p , g} = [ StopGrad ( {x}_{p , 1} … {x}_{p , g - 1} ) , {x}_{p , g} , StopGrad ( {x}_{p , g + 1} , … , {x}_{p , G} ) ,$$

where p and g index the patches and groups respectively. Similarly, each spatial location can also be copied communicated, masked, and then averaged locally, which is represented as:

$${\overline{x}}_{p , g} = \frac{1}{p} ( {x}_{p , g} + {\sum }_{{p}^{′} \neq p} StopGrad ( {x}_{{p}^{′} , g} ) )$$

The output of feature aggregation can be the same as that of the conventional global average pooling layer. The difference is that the above-described loss is replicated and different patch groups are activated in each loss.

### Example Methods

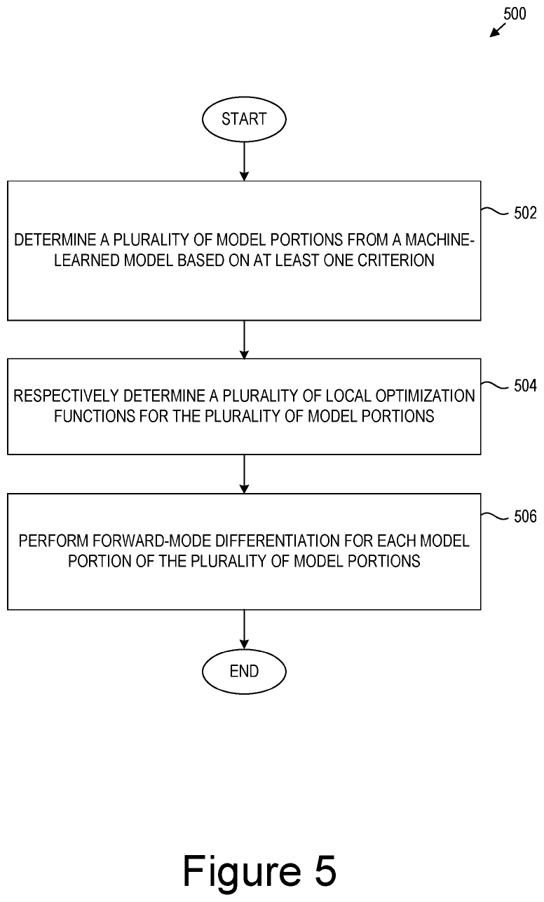

FIG. 5 depicts a flow chart diagram of an example method 500 to perform forward gradient learning according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system can determine a plurality of model portions from a machine-learned model based on at least one criterion.

At 504, the computing system can respectively determine a plurality of local optimization functions for the plurality of model portions.

At 506, the computing system can perform forward-mode differentiation for each model portion of the plurality of model portions. Performing the forward-mode differentiation includes applying a perturbation to outputs of one or more model units of the model portion. Performing the forward-mode differentiation includes, based at least in part on the perturbation, determining, by the computing system, a gradient of the local optimization function for the model portion. Performing the forward-mode differentiation includes modifying one or more parameters of the model portion based on the gradient.

In some implementations, the perturbation applied can be a weight perturbation to perform weight-perturbed forward gradient. For example, let w_{i,j} be the weight connection between unit i and j, and let f be the loss function. The gradient can be estimated by sampling a random matrix with IId elements v_{i,j} drawn from a zero-mean unit-variance Gaussian distribution. The estimator can be represented as:

$${g}_{w} ( {w}_{i , j} ) = ( {\sum }_{{i}^{′} {j}^{′}} ∇ {w}_{{i}^{′} {j}^{′}} {v}_{{i}^{′} {j}^{′}} ) {v}_{ij}$$

The estimator can sample a random perturbation direction vᵢⱼ and test how it aligns with the true gradient ∇w_{i,j}, by using forward-mode to perform the dot product, and then multiply the scalar alignment with the perturbation direction.

Additionally, or alternatively, in some implementations, the perturbation applied can be an activity perturbation to perform activity-perturbed forward gradient. For example, assume that a discrete-time rate-based formulation is utilized. Further assume that xᵢ denotes the activity of the i-th pre-synaptic neuron and zᵢ denotes that of the j-th post-synaptic neuron before the non-linear activation function, and let uⱼ represent the perturbation of zⱼ. The activity-perturbed forward gradient estimator can be represented as:

$${g}_{a} ( {w}_{i , j} ) = ( {\sum }_{{j}^{′}} ∇ {z}_{{j}^{′}} {u}_{{j}^{′}} ) {u}_{j}$$

where the inner product between ∇z and u is computed using forward-mode automatic differentiation.

In some implementations, a first model portion includes a plurality of model units, and applying the applying the perturbation to outputs of one or more model units of the first model portion includes identifying a first portion of the plurality of model units as being Rectified Linear Unit (ReLU) activation units, and a second portion of the plurality of model units as being units other than ReLU activation units, and applying the perturbation to outputs of the second portion of the plurality of model units.

In some implementations, the plurality of model portions include a first model portion and a second model portion. Performing the forward-mode differentiation for each model portion of the plurality of model portions includes applying a first perturbation to the outputs of the one or more model units of the first model portion and applying a second perturbation to the outputs of the one or more model units of the second model portion, wherein the second perturbation is different than the first perturbation.

In some implementations, each of the one or more parameters \dot{w}ᵢⱼ are modified in accordance with \dot{w}ᵢⱼ=xᵢ\dot{y}ⱼ\dot{r}, wherein xᵢ is presynaptic activity (e.g., activity before a model unit, etc.), \dot{y}ⱼ is a rate of change in postsynaptic activity, and \dot{r} is a rate of change of reward associated with the optimization function.

In some implementations, the at least one criterion includes a blockwise loss criterion that evaluates a depth dimension of the machine-learned model. Determining the plurality of model portions from the machine-learned model based on the at least one criterion includes determining the plurality of model portions from the machine-learned model based on the blockwise loss criterion that evaluates the depth dimension of the machine-learned model. Respectively determining the plurality of local optimization functions for the plurality of model portions includes respectively determining a plurality of localized greedy loss functions for the plurality of model portions.

In some implementations, the at least one criterion includes a patchwise loss criterion that evaluates spatial dimensions of an input to the machine-learned model. Determining the plurality of model portions from the machine-learned model based on the at least one criterion includes determining the plurality of model portions from the machine-learned model based on the patchwise loss criterion that evaluates the spatial dimensions of the input to the machine-learned model, wherein the plurality of model portions respectively correspond to a plurality of spatial regions of the input to the machine-learned model.

In some implementations, the at least one criterion includes a channel-wise loss criterion that evaluates a channel dimension of the machine-learned model. Determining the plurality of model portions from the machine-learned model based on the at least one criterion includes determining the plurality of model portions from the machine-learned model based on the channel-wise loss criterion that evaluates the channel dimension of the input to the machine-learned model, wherein the machine-learned model comprises a plurality of channels, and wherein each of the plurality of model portions comprises a grouping of channels of the plurality of channels.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
determining, by a computing system comprising one or more computing devices, a plurality of model portions from a machine-learned model based on at least one criterion:
respectively determining, by the computing system, a plurality of local optimization functions for the plurality of model portions:
performing, by the computing system, forward-mode differentiation for each model portion of the plurality of model portions, wherein performing the forward-mode differentiation comprises:
applying, by the computing system, a perturbation to outputs of one or more model units of the model portion:
based at least in part on the perturbation, determining, by the computing system, a gradient of the local optimization function for the model portion; and
modifying, by the computing system, one or more parameters of the model portion based on the gradient.

2. The computer-implemented method of claim 1, wherein a first model portion of the plurality of model portions comprises a plurality of model units; and
wherein applying the perturbation to outputs of one or more model units of the first model portion comprises:
identifying, by the computing system, a first portion of the plurality of model units as being Rectified Linear Unit (ReLU) activation units, and a second portion of the plurality of model units as being units other than ReLU activation units; and
applying, by the computing system, the perturbation to outputs of the second portion of the plurality of model units.

3. The computer-implemented method of claim 2, wherein the plurality of model portions comprises a first model portion and a second model portion; and
wherein performing the forward-mode differentiation for each model portion of the plurality of model portions comprises:
applying, by the computing system, a first perturbation to the outputs of the one or more model units of the first model portion; and
applying, by the computing system, a second perturbation to the outputs of the one or more model units of the second model portion, wherein the second perturbation is different than the first perturbation.

4. The computer-implemented method of claim 1, wherein each of the one or more parameters \dot{w}ᵢⱼ are modified in accordance with \dot{w}ᵢⱼ=xᵢ\dot{y}ⱼ\dot{r}, wherein xᵢ is presynaptic activity, \dot{y}ⱼ is a rate of change in postsynaptic activity, and \dot{r} is a rate of change of reward associated with the optimization function.

5. The computer-implemented method of claim 1, wherein the at least one criterion comprises a blockwise loss criterion that evaluates a depth dimension of the machine-learned model:
wherein determining the plurality of model portions from the machine-learned model based on the at least one criterion comprises determining, by the computing system, the plurality of model portions from the machine-learned model based on the blockwise loss criterion that evaluates the depth dimension of the machine-learned model; and
wherein respectively determining the plurality of local optimization functions for the plurality of model portions comprises respectively determining, by the computing system, a plurality of localized greedy loss functions for the plurality of model portions.

6. The computer-implemented method of claim 1, wherein the at least one criterion comprises a patchwise loss criterion that evaluates spatial dimensions of an input to the machine-learned model; and
wherein determining the plurality of model portions from the machine-learned model based on the at least one criterion comprises determining, by the computing system, the plurality of model portions from the machine-learned model based on the patchwise loss criterion that evaluates the spatial dimensions of the input to the machine-learned model, wherein the plurality of model portions respectively correspond to a plurality of spatial regions of the input to the machine-learned model.

7. The computer-implemented method of claim 1, wherein the at least one criterion comprises a channel loss criterion that evaluates a channel dimension of the machine-learned model; and
wherein determining the plurality of model portions from the machine-learned model based on the at least one criterion comprises determining, by the computing system, the plurality of model portions from the machine-learned model based on the channel loss criterion that evaluates the channel dimension of the input to the machine-learned model, wherein the machine-learned model comprises a plurality of channels, and wherein each of the plurality of model portions comprises a grouping of channels of the plurality of channels.

8. A computing system, comprising:
one or more processors; and
one or more non-transitory, computer-readable media that store instructions that when executed by the one or more processors cause the computing system to perform operations, the operations comprising:
determining a plurality of model portions from a machine-learned model based on at least one criterion;
respectively determining a plurality of local optimization functions for the plurality of model portions:
performing forward-mode differentiation for each model portion of the plurality of model portions, wherein performing the forward-mode differentiation comprises:
applying a perturbation to outputs of one or more model units of the model portion:
based at least in part on the perturbation, determining a gradient of the local optimization function for the model portion; and
modifying one or more parameters of the model portion based on the gradient.

9. The computing system of claim 8, wherein a first model portion of the plurality of model portions comprises a plurality of model units; and
wherein applying the perturbation to outputs of one or more model units of the first model portion comprises:
identifying a first portion of the plurality of model units as being Rectified Linear Unit (ReLU) activation units, and a second portion of the plurality of model units as being units other than ReLU activation units; and
applying the perturbation to outputs of the second portion of the plurality of model units.

10. The computing system of claim 8, wherein the plurality of model portions comprises a first model portion and a second model portion; and
wherein performing the forward-mode differentiation for each model portion of the plurality of model portions comprises:
applying a first perturbation to the outputs of the one or more model units of the first model portion; and
applying a second perturbation to the outputs of the one or more model units of the second model portion, wherein the second perturbation is different than the first perturbation.

11. The computing system of claim 8, wherein each of the one or more parameters \dot{w}ᵢⱼ are modified in accordance with \dot{w}ᵢⱼ=xᵢ\dot{y}ⱼ\dot{r}, wherein xᵢ is presynaptic activity, \dot{y}ⱼ is a rate of change in postsynaptic activity, and \dot{r} is a rate of change of reward associated with the optimization function.

12. The computing system of claim 8, wherein the at least one criterion comprises a blockwise loss criterion that evaluates a depth dimension of the machine-learned model:
wherein determining the plurality of model portions from the machine-learned model based on the at least one criterion comprises determining the plurality of model portions from the machine-learned model based on the blockwise loss criterion that evaluates the depth dimension of the machine-learned model; and
wherein respectively determining the plurality of local optimization functions for the plurality of model portions comprises respectively determining a plurality of localized greedy loss functions for the plurality of model portions.

13. The computing system of claim 8, wherein the at least one criterion comprises a patchwise loss criterion that evaluates spatial dimensions of an input to the machine-learned model; and
wherein determining the plurality of model portions from the machine-learned model based on the at least one criterion comprises determining the plurality of model portions from the machine-learned model based on the patchwise loss criterion that evaluates the spatial dimensions of the input to the machine-learned model, wherein the plurality of model portions respectively correspond to a plurality of spatial regions of the input to the machine-learned model.

14. The computing system of claim 8, wherein the at least one criterion comprises a channel loss criterion that evaluates a channel dimension of the machine-learned model; and
wherein determining the plurality of model portions from the machine-learned model based on the at least one criterion comprises determining the plurality of model portions from the machine-learned model based on the channel loss criterion that evaluates the channel dimension of the input to the machine-learned model, wherein the machine-learned model comprises a plurality of channels, and wherein each of the plurality of model portions comprises a grouping of channels of the plurality of channels.

15. One or more non-transitory, computer-readable media that store instructions that when executed by one or more processors cause the one or more processors to perform operations, the operations comprising:
determining a plurality of model portions from a machine-learned model based on at least one criterion;
respectively determining a plurality of local optimization functions for the plurality of model portions:
performing forward-mode differentiation for each model portion of the plurality of model portions, wherein performing the forward-mode differentiation comprises:
applying a perturbation to outputs of one or more model units of the model portion:
based at least in part on the perturbation, determining a gradient of the local optimization function for the model portion; and
modifying one or more parameters of the model portion based on the gradient.

16. The one or more non-transitory computer-readable media of claim 15, wherein a first model portion of the plurality of model portions comprises a plurality of model units; and
wherein applying the perturbation to outputs of one or more model units of the first model portion comprises:
identifying a first portion of the plurality of model units as being Rectified Linear Unit (ReLU) activation units, and a second portion of the plurality of model units as being units other than ReLU activation units; and
applying the perturbation to outputs of the second portion of the plurality of model units.

17. The one or more non-transitory computer-readable media of claim 15, wherein the plurality of model portions comprises a first model portion and a second model portion; and
wherein performing the forward-mode differentiation for each model portion of the plurality of model portions comprises:
applying a first perturbation to the outputs of the one or more model units of the first model portion; and
applying a second perturbation to the outputs of the one or more model units of the second model portion, wherein the second perturbation is different than the first perturbation.

18. The one or more non-transitory computer-readable media of claim 15, wherein each of the one or more parameters \dot{w}ᵢⱼ are modified in accordance with \dot{w}ᵢⱼ=xᵢ\dot{y}ⱼ\dot{r}, wherein xᵢ is presynaptic activity, \dot{y}ⱼ is a rate of change in postsynaptic activity, and \dot{r} is a rate of change of reward associated with the optimization function.

19. The one or more non-transitory computer-readable media of claim 15, wherein the at least one criterion comprises a blockwise loss criterion that evaluates a depth dimension of the machine-learned model:
wherein determining the plurality of model portions from the machine-learned model based on the at least one criterion comprises determining the plurality of model portions from the machine-learned model based on the blockwise loss criterion that evaluates the depth dimension of the machine-learned model; and
wherein respectively determining the plurality of local optimization functions for the plurality of model portions comprises respectively determining a plurality of localized greedy loss functions for the plurality of model portions.

20. The one or more non-transitory computer-readable media of claim 15, wherein the at least one criterion comprises a patchwise loss criterion that evaluates spatial dimensions of an input to the machine-learned model; and
wherein determining the plurality of model portions from the machine-learned model based on the at least one criterion comprises determining the plurality of model portions from the machine-learned model based on the patchwise loss criterion that evaluates the spatial dimensions of the input to the machine-learned model, wherein the plurality of model portions respectively correspond to a plurality of spatial regions of the input to the machine-learned model.
